(19) United States
(12) Patent Application Publication
(10) Pub. No.: US 2021/0341389 A1
(43) Pub. Date: Nov. 4, 2021

(54) SIMULTANEOUS TOP-DOWN AND ROTATIONAL SIDE-VIEW FLUORESCENCE IMAGER FOR EXCISED TISSUE

(71) Applicant: LI-COR, Inc., Lincoln, NE (US)

(72) Inventors: Han-Wei Wang, Lincoln, NE (US); Lyle R. Middendorf, Lincoln, NE (US)

(73) Assignee: LI-COR, Inc., Lincoln, NE (US)

(21) Appl. No.: 16/865,044

(22) Filed: May 1, 2020

(51) Int. Cl. G01N 21/64

(52) U.S. Cl. CPC G01N 21/6486; G01N 2201/12; G01N 2201/0668

(57) ABSTRACT

An imager for simultaneously taking full color pictures and fluorescence images from the same perspectives, top-down and side views, is presented that uses multiple cameras looking at the same stage through a beamsplitter and light sources for each view. The imager is configured to work with a particular fluorophore, or at least a predetermined fluorescence excitation wavelength and emission wavelength. A broadband white light source projects through a shortpass or other filter with a cut-off wavelength either lower than or between the excitation and emission wavelengths. Another shortpass or other filter is in front of a color camera with a cut-off wavelength below that of the emission wavelength, while a monochrome fluorescence camera may or may not have additional filters to bring out the fluorescence. These filters may be built into a dichroic mirror of the beamsplitter. In addition, digital processing may boost frequencies in the color image that were dampened by the filters.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH AND DEVELOPMENT

NOT APPLICABLE

### BACKGROUND

### 1. Field of the Invention

The present application generally relates to investigating or analyzing materials by the use of spatially resolved fluorescence measurements. Specifically, the application is related to taking simultaneous, or quick alternating, true color and fluorescence images of excised biological specimens, both top-down and around the sides, and digitally displaying them.

### 2. Description of the Related Art

Assessment of tumor margin during surgery can be essential to the optimal outcome of many oncologic procedures. Tumor margins are the healthy tissue surrounding the tumor, and more specifically, the distance between the tumor tissue and the edge of the surrounding tissue removed along with the tumor. Ideally, the margins are selected so that the risk of leaving tumor tissue within the patient is low.

Fluorescence image-guided surgery and fluorescence image-guided margin assessment are emerging technologies taking advantage of recent developments of fluorescence dyes and tumor targeting imaging agents from translational and clinical research areas. In recent years, some fluorescence imaging systems have been developed and commercialized for image-guided surgery. Some of these handheld and overhead devices have been tested for use in the margin assessment of tumors, rather than for their well-established purpose of imaging primary tumor tissues.

When these systems are used in situ with an image-guided systems above the wound bed, there exist significant ambient interferences such as those associated with broadband ambient light, wound bed fluids, and electromagnetism. These interferences, along with requirements for high frame rates for fluorescence imaging, together produce reduced detection limits or sensitivities of the devices. One approach to avoiding ambient light interferences is to dim operating room lights. Obviously, this can be disruptive. Another is the use of modulation of excitation light away from ambient frequencies. That is, rapidly blink on and off the excitation light.

However, modulation of excitation light necessarily results in less excitation of fluorescence dyes than if the excitation light were continuous, resulting in a reduced fluorescence signal. For example, a duty cycle of 50% of excitation light generally results in a fluorescence signal that is half as strong. Another issue is that there is a need for tight synchronization of the excitation light and light collection means.

There is a need in the art for better imaging systems to improve gross examination and margin status in surgeries and other medical procedures.

### BRIEF SUMMARY

Generally, an electronic imager is described that takes contemporaneous full color and fluorescence images of tissue by using dual-channel imaging assemblies. While a biological sample is on a stage, one dual-channel imaging assembly views the sample top-down, and another dual-channel imaging assembly views from the side. Each dual-channel imaging assembly has a dedicated color camera and a dedicated monochrome fluorescence camera that share a view through a beamsplitter. Each assembly also has a white light source and a fluorescence excitation light.

Light from each white light source is filtered with a bandpass, notch, or shortpass filter so that it avoids emitting light at the fluorescence emission wavelength and corrupting the fluorescence image. Because that wavelength (range) is blocked, the color image is digitally adjusted to compensate. As for the excitation wavelength, the cut-off wavelength of the shortpass filter may be above or below it.

Alternatively, or in addition, the color camera is filtered with a notch, longpass, or shortpass filter so as to minimize reflections from the excitation light. Like for emission wavelengths, the color image can be digitally adjusted to compensate for the filtered excitation wavelengths.

Some embodiments of the present invention are related to an imaging apparatus for resected tissue. The apparatus includes a sample stage, multiple dual-channel imaging assemblies, each dual-channel imaging assembly including i) a color camera having at least three different colored filter coatings over pixel sensors, ii) a fluorescence camera having a monochrome color coating or no color coating over pixel sensors, iii) a beamsplitter configured to reflect and transmit light from the sample stage to the cameras, iv) a white light source configured to illuminate the sample stage, and v) a fluorescence excitation light source aimed toward the sample stage, the fluorescence excitation light source having an excitation wavelength for stimulating fluorescence in a biocompatible dye at a predetermined emission wavelength, where at least one of the dual-channel imaging assemblies is configured for a top-down view of the sample stage, and at least one of the dual-channel imaging assemblies is configured for a side view of the sample stage. The apparatus also includes a computer processor operatively connected with a machine-readable, non-transitory medium embodying information indicative of instructions for causing the computer processor to perform operations including taking a color picture with the color camera simultaneously, alternating, or otherwise together with capturing a fluorescence image at the emission wavelength with the fluorescence camera in at least one of the dual-channel imaging assemblies, and rendering the color picture and the fluorescence image for output to a display.

The apparatus can include a bandpass, notch, or shortpass optical filter over the white light source, the optical filter configured to block the emission wavelength, thereby inhibiting specular or diffuse reflections caused by the white light source at the emission wavelength. The instructions can further include boosting, in the color picture from at least one of the dual-channel imaging assemblies, colors that are otherwise blocked at the emission wavelength.

The apparatus can include a notch, longpass, or shortpass optical filter over each color camera, the notch or longpass filter configured to block the excitation wavelength, thereby inhibiting saturation or artifacts caused by the fluorescence excitation light source at the excitation wavelength. The instructions can further include boosting, in the color picture, from at least one of the dual-channel imaging assemblies, colors that are otherwise blocked at the excitation wavelength. Each dual-channel imaging assembly can include an unfiltered white light source, wherein the operations further include taking a true color picture with the unfiltered white light source on while the fluorescence excitation light source is not irradiating, and using the true color picture for the boosting.

Each beamsplitter can incorporate a dichroic mirror that reflects or transmits light at the excitation wavelength away from, and reflects or transmits light at the emission wavelength to, the respective fluorescence camera. The dichroic mirror can include a bandpass, shortpass, or longpass mirror.

The apparatus can include a bandpass, notch, or longpass optical filter in front of each fluorescence camera, the optical filter blocking light at the excitation wavelength.

The sample stage can be a rotatable sample stage having an axis of rotation. The apparatus can further include a tilt bearing configured to rotate with the rotatable sample stage and tilt the sample stage, the tilt bearing having a tilt axis substantially orthogonal to the axis of rotation, and/or a translation bearing configured to move the rotatable sample stage perpendicular to the axis of rotation.

The color picture and the fluorescence image can be part of real-time video streams being rendered to the display. The operations can further include monitoring a rate of movement of a sample on the rotatable sample stage, determining that the rate of movement has descending below a threshold rate, sending, based on the determining, a trigger to the fluorescence cameras, and lengthening an integration time of the fluorescence camera pixel sensors based on the trigger. The operations can further include monitoring a rate of movement of a sample on the rotatable sample stage, determining that the rate of movement has descending below a threshold rate, and alternating, based on the determining, between taking color pictures while the white light source is illuminating and capturing fluorescence images while the fluorescence excitation light source is irradiating. The video streams can be from the top-down dual-channel imaging assembly and the side view dual-channel imaging assembly, and the video streams can be rendered for user-switchable or simultaneous viewing on the display.

The operations can further include overlaying the color picture and the fluorescence image in a computer memory for the display. Each color camera and fluorescence camera can have a same number of pixel sensors.

An angle between the top-down dual-channel imaging assembly and the side dual-channel imaging assembly can be 90 degrees. The excitation wavelength can be 400 nanometers (nm), 633 nm to 636 nm, 647 nm, 649 nm, 651 nm, 660 nm, 680 nm, 740 nm, 780 nm, 810 nm, 830 nm, and 850 nm, and the emission wavelength is between about 600 nanometers (nm) and 950 nm. The fluorescence excitation light source can include a light emitting diode (LED) or a laser.

Some embodiments are related to a method of imaging resected tissue, the method include providing a sample stage, providing multiple dual-channel imaging assemblies, each dual-channel imaging assembly including i) a color camera having at least three different colored filter coatings over pixel sensors, ii) a fluorescence camera having a monochrome color coating or no color coating over pixel sensors, and iii) a beamsplitter configured to reflect and transmit light from the sample stage to the cameras, where at least one of the dual-channel imaging assemblies is configured for a top-down view of the sample stage, and at least one of the dual-channel imaging assemblies is configured for a side view of the sample stage. The method includes illuminating a biological sample on the sample stage with a white light source, irradiating the biological sample, simultaneously, alternatingly, or otherwise together with the illuminating, with a fluorescence excitation light source at an excitation wavelength in order to stimulate fluorescence of a biocompatible dye within the biological sample at a predetermined emission wavelength, taking a color picture with the color camera simultaneously, alternatingly, or otherwise together with capturing a fluorescence image at the emission wavelength with the fluorescence camera in at least one of the dual-channel imaging assemblies, and rendering the color picture and the fluorescence image for output to a display.

The illuminating from the white light source can be through a bandpass, notch, or shortpass optical filter that blocks the emission wavelength from the white light source, thereby inhibiting or preventing specular or diffuse reflections caused by the white light source at the emission wavelength.

The sample stage can be a rotatable sample stage having an axis of rotation.

The color picture and the fluorescence image can be part of real-time video streams being rendered to the display, and the method can further include monitoring a rate of movement of the biological sample on the rotatable sample stage, determining that the rate of movement has descending below a threshold rate, sending, based on the determining, a trigger to the fluorescence cameras, and lengthening an integration time of the fluorescence camera pixel sensors based on the trigger.

The color picture and the fluorescence image can be part of real-time video streams being rendered to the display, and the method can further include monitoring a rate of movement of the biological sample on the rotatable sample stage, determining that the rate of movement has descending below a threshold rate, and alternating, based on the determining, between taking color pictures while the white light source is illuminating and capturing fluorescence images while the fluorescence excitation light source is irradiating.

### BRIEF DESCRIPTION OF THE DRAWINGS

FIG. 1A illustrates an imaging device in accordance with an embodiment.

FIG. 1B is a close up illustration of one of the dual-channel imaging assemblies of FIG. 1A.

FIG. 2 is a flow diagram illustrating spectral changes in a configuration where the wavelengths of white light do not overlap that of the excitation light in accordance with an embodiment.

FIG. 3 is a flow diagram illustrating spectral changes in a configuration where the wavelengths of white light overlap that of the excitation light in accordance with an embodiment.

FIG. 4A illustrates (in a black & white line drawing) a full color, top-down view of a sample in accordance with an embodiment.

FIG. 4B illustrates a fluorescence, top-down view of the sample of FIG. 4A.

FIG. 4C illustrates a fluorescence, side view of the sample of FIG. 4A.

FIG. 5 is a flowchart illustrating an embodiment in accordance with the present invention.

### DETAILED DESCRIPTION

Embodiments are related to medical sample imaging devices that can simultaneously, or nearly simultaneously, take full color and fluorescence images, including real time video, of a resected tissue sample. Dual-channel imaging assemblies, each with a full color camera and a monochrome fluorescence camera, are pointed at a sample on a fixed stage or turntable. One of the dual-imaging assemblies can be positioned with its viewing axis aligned with and coterminous with (i.e., on top of) the axis of the stage, while another of the dual-imaging assemblies can be positioned for a side view.

“Full color” includes substantially all wavelengths (λ) of electromagnetic radiation within the spectrum of light that is visible to humans, or as otherwise known in the art. Commercially available color cameras often includes color filter arrays over their sensors. The color filter arrays typically include at least three different colored filter coatings, such as red, green, and blue, over their pixel sensors. Red, yellow, and blue color filter arrays, as well as cyan, yellow, and magenta color filter arrays, are common as well. These can all be used for (full) color cameras.

A “monochrome” color coating includes a coating in which substantially all of the coating is clear, a single shade of transparent gray, one translucent color, or as otherwise known in the art. A monochrome camera typically has a greater resolution than an equivalent color camera because each pixel can detect every impinging visible wavelength instead of only detecting certain colors. In some embodiments, color and monochrome cameras may be exactly the same except for the color filter arrays over their pixel sensors.

Each dual-imaging assembly includes a beamsplitter that transmits and reflects light from the sample stage area where the sample is placed, that is, an imaging volume, to the full color and fluorescence cameras. The beamsplitter may incorporate filters in the form of coatings on its mirror or separate filter assemblies.

Each dual-imaging assembly includes a white light source and a fluorescence excitation source positioned to project toward and illuminate/irradiate the imaging volume. Each of the light sources may have a filter or multiple filters that block certain frequencies from being emitted by the source into the imaging volume. For example, the excitation source may have a filter that blocks light at the intended emission wavelengths so that reflections of the intense source do not falsely show as fluorescence.

Alternatively, or in addition, the cameras may include filters that block certain wavelengths/frequencies to compensate for reflections from the excitation light or fluorescence emissions. Digital enhancement of the white light, full color pictures may compensate for the filters, intensity of the excitation light, and/or low signal of the emission light.

In many medical imaging applications, it can be beneficial to have an accurate and responsive interactive real-time view of a subject that an operator can use as a navigational guide for examining the subject. It can also be beneficial to have enhanced images of the subject that the operator can use to collect more detailed information related to a view of the subject once navigated to. Often, the qualities of such an enhanced image that make it useful for closer investigations also make the enhanced image poor for use in real-time navigation. For this reason, switching between different imaging functions can be helpful. In this way, for example, when the movement of a real-time view has substantially stopped, functional imaging parameters or functional imaging channels can be switched on as enhancements to provide additional information such as enhanced imaging quality, longer integration for better sensitivity, individual channel activation (e.g., fluorescence imaging without true color), additional imaging modalities, X-ray shots, overlapping of channels, filtering applications, color changes, adding computational results, and augmented information. The methods and systems can therefore be particularly helpful in identifying and characterizing areas of interest in real-time to assist in the localization of disease tissue in either a surgical suite or a pathology lab.

Thus, some embodiments incorporate user-selectable switching between imaging functions, channels, or any combination of the features mentioned above.

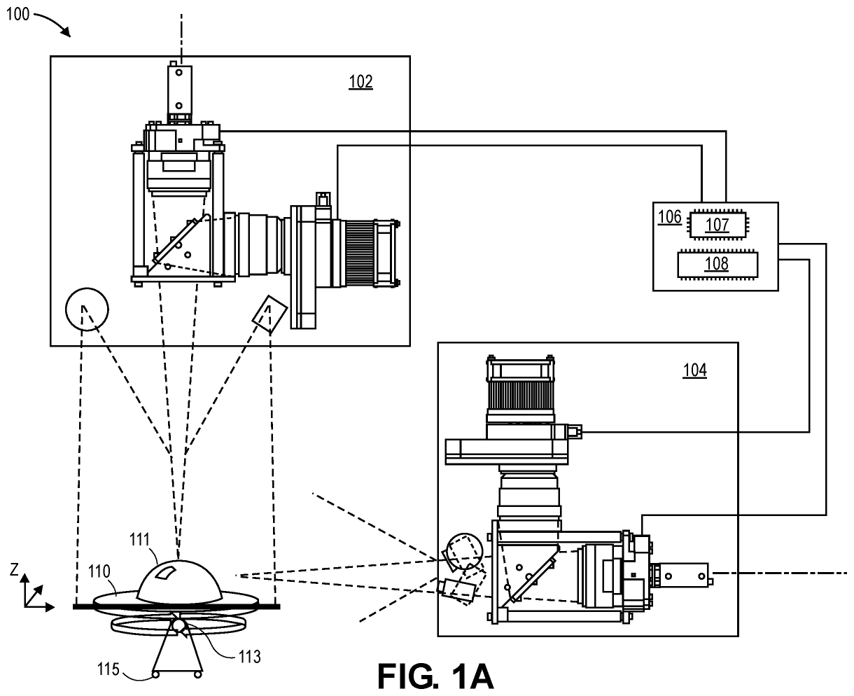

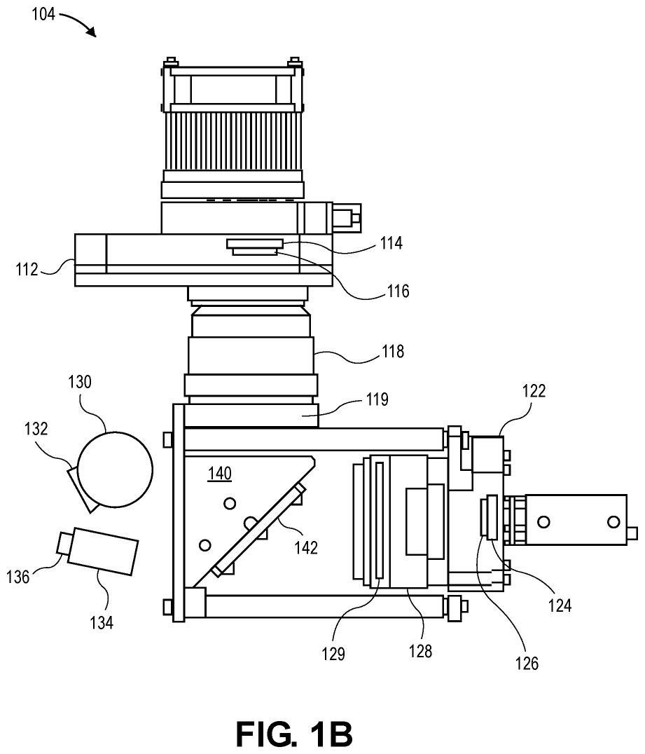

FIGS. 1A-1B illustrate an imaging device 100 with a pair of dual-channel imaging assemblies, 102 and 104 connected to computer system 106.

In FIG. 1A, dual-channel imaging assembly 102 is configured for a top-down view of sample stage 110. Its light path peers down over sample 111, which is supported by sample stage 110, the view direction being substantially perpendicular to the stage and parallel with the axis of rotation of sample stage 110. Its view axis is actually on top of, or coterminous with, the rotational axis of the sample stage.

Although dual-channel imaging assembly 102 is shown above the sample stage, in some embodiments the dual-channel imaging assembly may be located elsewhere, such as the side, underneath, etc. the light stage, and its light path fed by mirrors or other optics so that its view is from the top.

Dual-channel imaging assembly 104 is configured for a side view of sample stage 110.

Its light path central axis is substantially parallel with the plane of the sample stage 110, perpendicular to its axis of rotation.

Although dual-channel imaging assembly 104 is shown beside the sample stage, like dual-channel imaging assembly 102 it can be located elsewhere, such as above, underneath, etc. the light stage, and its light path fed by optics so that its view is from the side.

In some embodiments, the dual-channel imaging assemblies can be adjacent and aligned with one another with mirrors positioned to reflect light from the top and from the side. Locating the assemblies adjacent to one another can have several advantages. For example, it can minimize the routing of cabling to the computer system, and it can minimize the length of refrigerant/cooling lines to the fluorescent cameras. Another advantage is that it redistributes the center of gravity of the overall instrument, for example to make it less top heavy. Relocating the assemblies may also help attain defined overall system dimensions for certain form-factor requirements.

Sample stage 110 rotates 360° along a vertical, Z axis so that sample 111 can be turned in azimuth and viewed by side imaging assembly 104 all around. The rotation is precisely controlled by a stepper motor that is able to accurately position the sample stage at sub-1° azimuth angles. This may be helpful for automatically taking images and stitching them together as well as revisiting precise viewing angles of the sample.

Sample stage 110 is mounted on tilt bearing 113, which is configured to tilt the sample stage at angles up to 15, 30, 45, or 60°. Tilt bearing 113 has a tilt axis that, as shown in the figure, goes in and out of the page, which is substantially orthogonal to the sample stage's vertical axis of rotation.

Translation bearing 115 supports the mechanism upon which tilt bearing 113 is based.

It is configured to move the rotatable sample stage in X, Y directions that are perpendicular to the Z axis of rotation, that is, horizontally and in and out of the page in the figure. The translation bearing can help in centering a sample in the imaging volume of sample stage 110, adjusting focus, or simply transporting the sample into an otherwise difficult-to-reach area within a light tight enclosure.

In some embodiments, the sample stage is fixed and does not rotate or tilt. In other embodiments the sample stage can rotate but not tilt or translate. In other embodiments the sample stage can tilt, but not rotate or translate. In others the sample stage can translate only. Any combination of rotation, title, or translate ability for the sample stage can be used.

Both dual-channel imaging assemblies 102 and 104 are operatively connected with computer system 106, which includes computer processor 107 operatively connected with memory 108. Memory 108 is a machine-readable, non-transitory medium embodying information indicative of instructions for causing computer processor 107 to perform operations. Computer system 106 can both receiving data from the imaging assemblies as well as command operations, such as turning on and off lights, opening and closing shutters, performing readouts of data, and other commands. It can synchronize or alternate commands between the imaging assemblies.

The computer system may be in the same housing in which the imaging assemblies are located or positioned elsewhere, local or geographically remote. For example, the computer system may be a separate personal computer (PC) connected wirelessly or by cabling to the dual-channel imaging assemblies.

FIG. 1B is an expanded view of side view dual-channel imaging assembly 104. The dual-channel imaging assembly includes a fluorescence camera, a full color camera, beamsplitter, and light sources.

In the figure, light from the sample comes from the left side of the figure. Fluorescence camera 112 is positioned at a right angle to the incoming light. Fluorescence camera 112 includes pixel sensors 114 with monochrome color coating 116 over the pixel sensors. The monochrome coating is options. It also includes lens 118 and optical filter 119 in front.

Optical filter 119 can be a bandpass, notch, or longpass optical filter selected to block light at the excitation wavelength of a target fluorophore and avoid blocking light at the emission wavelength. After all, the goal of the camera is to image what can be very dim fluorescence. A longpass filter can be used if its cut-on wavelength is between that of the excitation and emission wavelengths because the emission wavelength of a fluorophore is almost always longer (i.e., a lower frequency) than that of a corresponding excitation wavelength. For example, an excitation wavelength of 680 nm (nanometers) causes emissions at or above 700 nm in some fluorophores. As another example, an excitation wavelength of 780 nm causes emissions at or above 800 nm in other fluorophores. As yet another example an excitation wavelength of 400 nm causes emissions with a peak at 620 nm.

It is possible with some fluorophores that incorporate nanoparticles, or using nonlinear imaging, that an excitation wavelength can cause emission at a shorter emission wavelength. This is sometimes referred to as “upconversion excitation” or “upconversion fluorescence.”

A filter is “in front of” a camera if it is placed in the optical path that the camera is configured to view, or as otherwise known in the art.

Color camera 122 is aligned with that of incoming light (from the left) and includes pixel sensors 124 with red, green, and blue colored filter coatings 126 over them. A common color filter array is a Bayer color filter, which includes a red, two green, and one blue filter for each set of four pixels. The camera includes lens 128 and optical filter 129 in front.

Optical filter 129 can be a notch, longpass, or shortpass optical filter configured to block light at the excitation wavelength of the target fluorophore. Lighting to excite the fluorophore can be intense and in a narrow band, causing artifacts in what would otherwise be a natural light view of the sample. Filter 129 inhibits saturation or artifacts caused by the excitation light from the fluorescence light source.

Beamsplitter 140 is configured to reflect light from a partially reflective mirror positioned at 45° into fluorescence camera 112 and allows light to transmit through the partially reflective mirror into color camera 122.

Dichroic mirror 142 is incorporated within beamsplitter, either by fastening to or replacing the partially reflective mirror. It can be a bandpass, shortpass, or longpass mirror at its specified frequencies. Dichroic mirror 142 allows light at the excitation wavelength to transmit through it to color camera 122, away from fluorescence camera 112. Meanwhile, it reflects light at the emission wavelength to fluorescence camera 112, away from color camera 122.

In some embodiments, the positions of the color and fluorescence cameras are reversed from the positions shown in FIG. 1B, that is, the color camera can be positioned at a right angle to the incoming light.

White light source 130 is mounted to illuminate sample stage 110 (see FIG. 1A), that is, the imaging volume atop the stage where samples may be placed. Filter 132 is mounted in front of white light source 130. The optical filter can be a bandpass, notch, or shortpass filter that is configured to block the emission wavelength. This prevents, limits, or otherwise inhibits specular or diffuse reflections caused by the white light source at the emission wavelength.

Fluorescence excitation light 134 is also positioned to illuminate the sample stage. It can be a laser, light emitting diode (LED), or other light with intensity at the desired excitation wavelength. Filter 136 is positioned over the excitation light in order to narrow its range of frequencies to those most likely to excite the target fluorophore. Filter 136 can be integral to the fluorescence excitation light source or attached as a separate component.

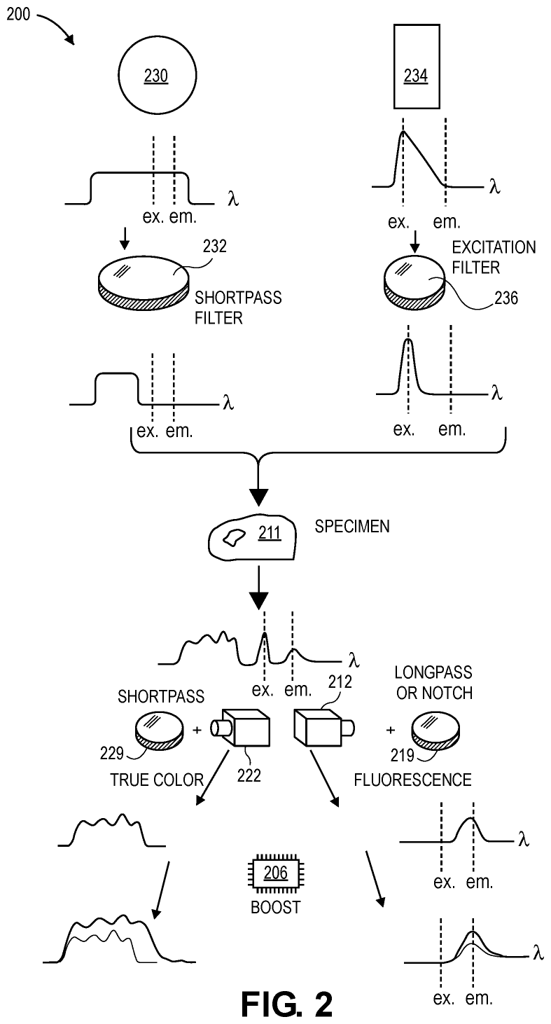

FIG. 2 illustrates spectral changes resulting from a filter over a white light source, among other things. In process 200, white light source 230 emits a broad band of wavelengths that includes those of the fluorophore's excitation and emission wavelengths. The excitation and/or emission wavelengths may be in the infrared or other nonvisible bands. The broadband light travels through shortpass filter 232, which has a cut-off wavelength below that of the excitation wavelength. Thus, the broad band of light from the white light source is altered so that, in this case, only wavelengths below the excitation and emission wavelengths pass through.

In the case that the excitation and emission wavelengths are in the visible range, the result may be a slightly blueish, if not detectable as blueish to the human eye, white light.

Meanwhile, fluorescence light source 234 emits an intense, narrower range of wavelengths maximized around the excitation wavelength. To minimize wavelengths at the emission wavelength, the light is passed through excitation filter 236. This results in a very narrow range of wavelengths, efficiently around the excitation wavelength, passing through as an excitation light.

Both the slightly blueish white light and excitation light fall upon sample specimen 211. The white light reflects and scatters naturally off the sample. The excitation light excites fluorophore within the sample.

In certain aspects, the illumination of the biological sample with broadband visible light is performed at one or more wavelengths of about 380 nm to about 700 nm. These wavelengths include, for example, about 380, 390, 400, 425, 450, 475, 500, 525, 550, 575, 600, 625, 650, 675, or about 700 nm.

The illumination of the biological sample can be in the near infrared, performed at one or more wavelengths of about 650 nm to about 1400 nm. These wavelengths include, for example, about 700, 725, 750, 775, 800, 825, 850, 875, 900, 910, 920, 930, 940, 950, 960, 970, 980, 990, 1000, 1100, 1200, 1300, and 1400 nm. Sometimes these wavelengths are referred to as being in the NIR-I (between 750 and 1060 nm) and NIR-II (between 1000 nm and 1700 nm) wavelength regions.

The biological sample is infused with fluorescent dye. The fluorescent group can be a near-infrared (NIR) fluorophore that emits in the range of between about 650 to about 1400 nm, or other wavelengths, such as those in the visible region, as fit. Use of near infrared fluorescence technology is advantageous in the methods herein as it substantially eliminates or reduces background from auto fluorescence of tissue. Another benefit to the near-IR fluorescent technology is that the scattered light from the excitation source is greatly reduced since the scattering intensity is proportional to the inverse fourth power of the wavelength. Low background fluorescence and low scattering result in a high signal to noise ratio, which is essential for highly sensitive detection. Furthermore, the optically transparent window in the near-IR region (650 nm to 990 nm) or NIR-II region (between about 1000 nm and 1400) in biological tissue makes NIR fluorescence a valuable technology for imaging and subcellular detection applications that require the transmission of light through biological components.

In certain aspects, the fluorescent group is preferably selected from the group consisting of IRDye® 800RS, IRDye® 800CW, IRDye® 800, Alexa Fluor® 660, Alexa Fluor® 680, Alexa Fluor® 700, Alexa Fluor® 750, Alexa Fluor® 790, Cy5, Cy5.5, Cy7, DY 676, DY680, DY682, and DY780. In certain aspects, the near infrared group is IRDye® 800CW, IRDye® 800, IRDye® 700DX, IRDye® 700, or Dynomic DY676. Indocyanine green (ICG) can also be used.

In certain aspects, the fluorescent dye is contacted with the biological sample prior to excising the biological sample from the subject. For example, the dye can be injected or administered to the subject prior to surgery or after surgery. In some instances, a surgeon can “paint” a tumor with the dye.

The fluorescent dye can be contacted with the biological sample after excising the biological sample from the subject. In this manner, dye can contacted to the tissue at the margins. In certain aspects, the biological sample comprises a tumor, such as tumor tissue or cells.

The dye can be conjugated to an antibody, ligand, or targeting moiety having an affinity to a tumor or recognizes a tumor antigen. The fluorescent dye can include a targeting moiety.

In some aspects, the targeting molecule is an antibody that binds an antigen such as a lung cancer cell surface antigen, a brain tumor cell surface antigen, a glioma cell surface antigen, a breast cancer cell surface antigen, an esophageal cancer cell surface antigen, a common epithelial cancer cell surface antigen, a common sarcoma cell surface antigen, or an osteosarcoma cell surface antigen.

The sample is then viewed by the cameras. Reflected light, from the white light and excitation light, and fluorescently emitted light are passed to the beamsplitter (not shown in the figure) to each of the color and fluorescence cameras.

Shortpass filter 229 removes the reflected excitation light and emitted fluorescence before imaging by color camera 222. The filter's cut-off wavelength is below that of the excitation wavelength. This leaves a somewhat true color view of the sample.

Because some of the longer, reddish wavelengths have been damped by shortpass filter 232 and shortpass filter 229, those wavelengths are digitally boosted in computer system 206 before displaying to a user so as to present the truest color possible.

The digital boosting may be calibrated by taking a full color picture without the excitation light on, or with a filter removed, and comparing to one with the excitation light, or with the filter in place. Computer system 106 (FIG. 1) can turn on the unfiltered white light source, take a true color picture while the fluorescence excitation light source is not irradiating, and save the color and intensity information for use in boosting wavelengths.

Meanwhile, longpass (or notch) filter 219 blocks excitation light reflected from the sample before imaging by fluorescence camera 212. This may prevent saturation and spectral crosstalk in the monochrome fluorescence camera. The emission light, typically dim, is digitally boosted in computer system 206 before displaying, recording, or processing the resulting fluorescence image.

The user, and any analyzing computer system, now has access to a relatively true, full color image of sample specimen 211 and a simultaneous image of its fluorescence. The location of fluorescence indicates the location of target tissue, such as a tumor. This may be shown in a real-time video stream being rendered to a display. It can also be saved as high-resolution pictures.

With a real-time video display, the user may interact with the sample by rotating it, panning, zooming, and otherwise manipulating the views. The top-down and side views may be displayed on the same or separate displays. The fluorescence images may be combined with the true-color images or positioned side by side.

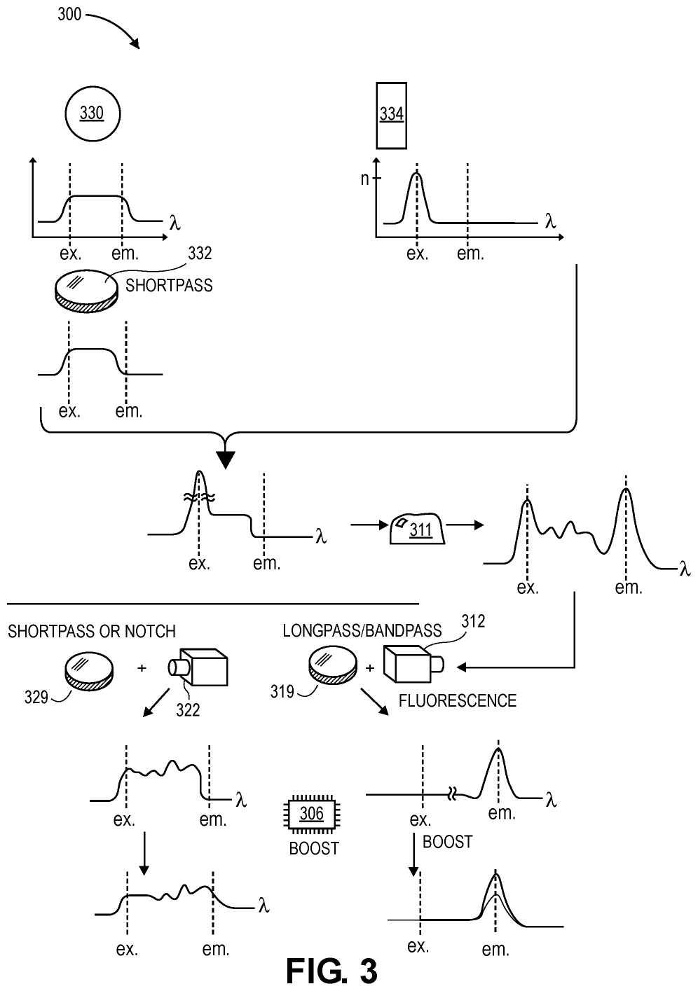

FIG. 3 is a flow diagram illustrating spectral changes caused by a filter over a color camera in accordance with an embodiment. In process 300, white light source 330 emits a broad band of wavelengths that includes those of the fluorophore's excitation and emission wavelengths. The broadband light travels through shortpass filter 332 that has a cut-off wavelength between the excitation and emission wavelengths. The broad band of wavelengths is altered so that, in this case, wavelengths below the emission wavelength passes through. This includes the excitation wavelength.

Meanwhile, fluorescence light source 334 emits an intense, narrower range of wavelengths maximized around the excitation wavelength. No excitation filter is present in this case.

Both the white light and excitation light fall upon sample specimen 311. The white light reflects and scatters naturally off the sample. Besides reflecting, the excitation light excites fluorophore within the sample.

Reflected light, from the white light and excitation light, and fluorescently emitted light are passed to the beamsplitter (not shown in the figure) to each of the color and fluorescence cameras.

Notch (or shortpass) filter 329 removes the reflected excitation light and emitted fluorescence before imaging by color camera 322. Because some of the longer, reddish wavelengths have been damped by shortpass filter 332 and notch filter 329, those wavelengths are digitally boosted in computer system 306 before displaying to a user.

Meanwhile, longpass (or bandpass) filter 319 blocks excitation light reflected from the sample before imaging by fluorescence camera 312. The emission light, typically dim, is digitally boosted by computer system 306.

At this point, the user, and any analyzing computer system, has access to a relatively true, full color image of sample specimen 311 and a simultaneous image of its fluorescence.

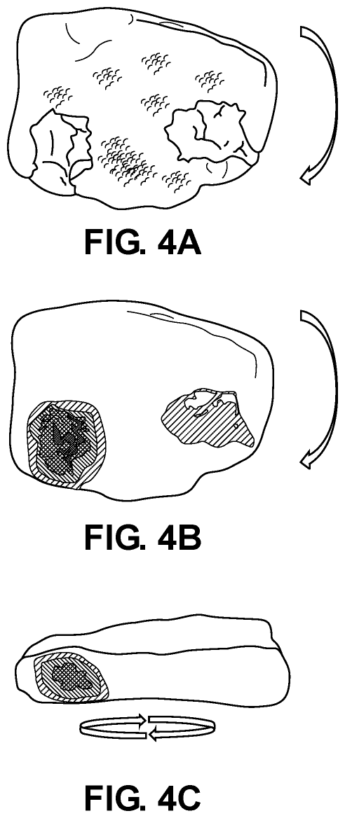

FIGS. 4A-4C illustrate views provided from the dual-channel imaging apparatus as described. FIG. 4A shows a top down view of the sample as a surgeon or other user would see with his or her own eyes (as a black & white line drawing), or at least a view through a full color still or video camera. FIG. 4B illustrates, from the same view as FIG. 4A, the intricate boundaries of fluorescence detected by the fluorescence camera, for example indicating to the surgeon where there is enough margin around an excised tumor. FIG. 4C illustrates a side view of the sample in fluorescence. A full color side view is also available.

By rotating the sample on the stage through 360°, the user can see just about any view of the sample except for the bottom. For example, the user can see the top from any orientation, and any side all the way around can be viewed. This can let the user best determine what view is optimal for making actionable decisions for surgery, medical evaluations, or otherwise.

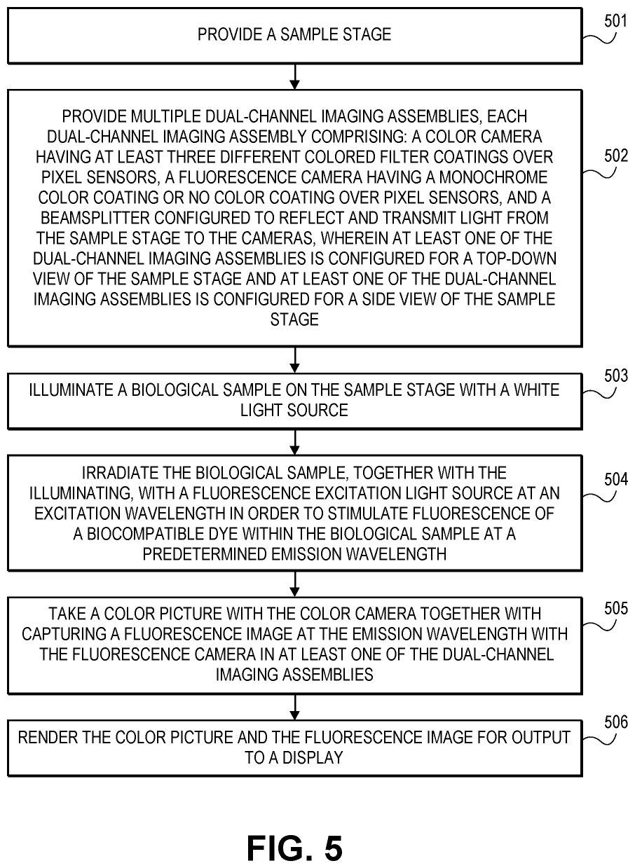

FIG. 5 is a flowchart of a process in accordance with an embodiment. In operation 501, a sample stage is provided. In operation 502, multiple dual-channel imaging assemblies are provided, each dual-channel imaging assembly includes a color camera having at least three different colored filter coatings over its pixel sensors, a fluorescence camera having a monochrome color coating or no color coating over its pixel sensors, and a beamsplitter configured to reflect and transmit light from the sample stage to the cameras. At least one of the dual-channel imaging assemblies is configured for a top-down view of the sample stage. At least one of the dual-channel imaging assemblies is configured for a side view of the sample stage. In operation 503, a biological sample on the sample stage is illuminated with a white light source. In operation 504, the biological sample is irradiated, simultaneously, alternatingly, or otherwise together with the illuminating, with a fluorescence excitation light source at an excitation wavelength in order to stimulate fluorescence of a biocompatible dye within the biological sample at a predetermined emission wavelength. In operation 505, a color picture is taken with the color camera simultaneously, alternatingly, or otherwise together with capturing a fluorescence image at the emission wavelength with the fluorescence camera in at least one of the dual-channel imaging assemblies. In operation 506, the color picture and the fluorescence image are rendered for output to a display.

The color picture and fluorescence image can be displayed side-by-side, overlapped with one another, coterminous with one another, alternatingly flashed on a screen, or otherwise exhibited for a user to determine where on a sample, in relation to landmarks and features on its true color, “natural” view, various levels of fluorescence are.

In some aspects, while the rotational stage 110 (FIG. 1) is in motion above a selected target motion rate, the cameras record a real-time view of the biological sample using a first frame rate frequency. When the motion rate of the rotational stage descends below this target rate, a trigger is sent to the camera, and the frame frequency of the camera is switched from the first frame frequency to a second, lower frame frequency. The camera then captures a second real-time view of the biological sample. As a result of the lower frame frequency used to capture and output this second real-time view, the amount of light collected in each frame is increased, and the sensitivity to the faint signals of the fluorescent region is increased. Accordingly, the intensity of the perceived fluorescent signal is greater in the second real-time view than in the first real-time view. When the motion rate is sped up again, the frame frequency of the fluorescence camera can be increased again.

In some embodiments, the motion rate may be monitored, and—when the rate of movement has descended below a threshold rate, alternating between taking color pictures while the white light source is illuminating and capturing fluorescence images while the fluorescence excitation light source is irradiating. This can be offered as a separate mode in the imaging apparatus.

The devices and methods can utilize a computing apparatus that is programmed or otherwise configured to automate and/or regulate one or more steps of the methods or features of the devices provided herein. Some embodiments provide machine executable code in a non-transitory storage medium that, when executed by a computing apparatus, implements any of the methods or operates any of the devices described herein. In some embodiments, the computing apparatus operates one or more power sources, motors, and/or displays. A display can be used for review of the real-time views. The display can be a touch screen to receive interactive command inputs. The display can be a wireless device relaying the information wirelessly.

The terms “first”, “second”, “third”, “fourth”, and “fifth”, and “sixth” when used herein with reference to images, views, frequencies, cameras, illuminations, wavelengths, intensities, modulations, resolutions, fields of view, axes, or other elements or properties are simply to more clearly distinguish the two or more elements or properties and unless stated otherwise are not intended to indicate order.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

1. An imaging apparatus for resected tissue, the apparatus comprising:
a sample stage;
multiple dual-channel imaging assemblies, each dual-channel imaging assembly comprising:
a color camera having at least three different colored filter coatings over pixel sensors;
a fluorescence camera having a monochrome color coating or no color coating over pixel sensors;
a beamsplitter configured to reflect and transmit light from the sample stage to the cameras;
a white light source configured to illuminate the sample stage;
a fluorescence excitation light source aimed toward the sample stage, the fluorescence excitation light source having an excitation wavelength for stimulating fluorescence in a biocompatible dye at a predetermined emission wavelength;
a bandpass, notch, or shortpass optical filter over the white light source, the optical filter configured to block the emission wavelength, thereby inhibiting specular or diffuse reflections caused by the white light source at the emission wavelength.
wherein at least one of the dual-channel imaging assemblies is configured for a top-down view of the sample stage, and at least one of the dual-channel imaging assemblies is configured for a side view of the sample stage; and
a computer processor operatively connected with a machine-readable, non-transitory medium embodying information indicative of instructions for causing the computer processor to perform operations comprising:
taking a color picture with the color camera together with capturing a fluorescence image at the emission wavelength with the fluorescence camera in at least one of the dual-channel imaging assemblies; and
rendering the color picture and the fluorescence image for output to a display.

2. (canceled)

3. The apparatus of claim 1 wherein the operations further comprise:
boosting, in the color picture from at least one of the dual-channel imaging assemblies, colors that are otherwise blocked at the emission wavelength.

4. An imaging apparatus for resected tissue, the apparatus comprising:
a sample stage;
multiple dual-channel imaging assemblies, each dual-channel imaging assembly comprising:
a color camera having at least three different colored filter coatings over pixel sensors;
a fluorescence camera having a monochrome color coating or no color coating over pixel sensors;
a beamsplitter configured to reflect and transmit light from the sample stage to the cameras;
a white light source configured to illuminate the sample stage;
a fluorescence excitation light source aimed toward the sample stage, the fluorescence excitation light source having an excitation wavelength for stimulating fluorescence in a biocompatible dye at a predetermined emission wavelength:
a notch, longpass, or shortpass optical filter over each color camera, the filter configured to block the excitation wavelength, thereby inhibiting saturation or artifacts caused by the fluorescence excitation light source at the excitation wavelength;
wherein at least one of the dual-channel imaging assemblies is configured for a top-down view of the sample stage, and at least one of the dual-channel imaging assemblies is configured for a side view of the sample stage; and
a computer processor operatively connected with a machine-readable, non-transitory medium embodying information indicative of instructions for causing the computer processor to perform operations comprising:
taking a color picture with the color camera together with capturing a fluorescence image at emission wavelength with the fluorescence camera in at least one of the dual-channel; imaging assemblies; and
rendering the color picture and the fluorescence image for output to a display.

5. The apparatus of claim 4 wherein the operations further comprise:
boosting, in the color picture from at least one of the dual-channel imaging assemblies, colors that are otherwise blocked at the excitation wavelength.

6. The apparatus of claim 5 wherein each dual-channel imaging assembly further comprises:
an unfiltered white light source,
wherein the operations further comprise:
taking a true color picture with the unfiltered white light source on while the fluorescence excitation light source is not irradiating; and
using the true color picture for the boosting.

7. The apparatus of claim 1 wherein each beamsplitter incorporates a dichroic mirror that reflects or transmits light at the excitation wavelength away from, and reflects or transmits light at the emission wavelength to, the respective fluorescence camera.

8. The apparatus of claim 7 wherein the dichroic mirror includes a bandpass, shortpass, or longpass mirror.

9. The apparatus of claim 1 further comprising:
a bandpass, notch, or longpass optical filter in front of each fluorescence camera, the optical filter blocking light at the excitation wavelength.

10. The apparatus of claim 1 wherein the sample stage is a rotatable sample stage having an axis of rotation.

11. The apparatus of claim 10 further comprising:
a tilt bearing configured to rotate with the rotatable sample stage and tilt the sample stage, the tilt bearing having a tilt axis substantially orthogonal to the axis of rotation; and/or
a translation bearing configured to move the rotatable sample stage perpendicular to the axis of rotation.

12. The apparatus of claim 10 wherein the color picture and the fluorescence image are part of real-time video streams being rendered to the display.

13. The apparatus of claim 12 wherein the operations further comprise:
monitoring a rate of movement of a sample on the rotatable sample stage;
determining that the rate of movement has descending below a threshold rate;
sending, based on the determining, a trigger to the fluorescence cameras; and
lengthening an integration time of the fluorescence camera pixel sensors based on the trigger.

14. The apparatus of claim 12 wherein the operations further comprise:
monitoring a rate of movement of a sample on the rotatable sample stage;
determining that the rate of movement has descending below a threshold rate; and
alternating, based on the determining, between taking color pictures while the white light source is illuminating and capturing fluorescence images while the fluorescence excitation light source is irradiating.

15. The apparatus of claim 12 wherein the video streams are from the top-down dual-channel imaging assembly and the side view dual-channel imaging assembly; and
the video streams are rendered for user-switchable or simultaneous viewing on the display.

16. The apparatus of claim 1 wherein the operations further comprise:
overlaying the color picture and the fluorescence image in a computer memory for the display.

17. The apparatus of claim 1 wherein each color camera and fluorescence camera have a same number of pixel sensors.

18. The apparatus of claim 1 wherein an angle between the top-down dual-channel imaging assembly and the side dual-channel imaging assembly is 90 degrees.

19. The apparatus of claim 1 wherein the excitation wavelength is selected from the group consisting of 400 nanometers (nm), 633 nm to 636 nm, 647 nm, 649 nm, 651 nm, 660 nm, 680 nm, 740 nm, 780 nm, 810 nm, 830 nm, and 850 nm, and the emission wavelength is between about 600 nanometers (nm) and 950 nm.

20. The apparatus of claim 1 wherein the fluorescence excitation light source includes a light emitting diode (LED) or a laser.

21. A method of imaging resected tissue, the method comprising:
providing a sample stage;
providing multiple dual-channel imaging assemblies, each dual-channel imaging assembly comprising:
a color camera having at least three different colored filter coatings over pixel sensors;
a fluorescence camera having a monochrome color coating or no color coating over pixel sensors; and
a beamsplitter configured to reflect and transmit light from the sample stage to the cameras;
wherein at least one of the dual-channel imaging assemblies is configured for a top-down view of the sample stage, and at least one of the dual-channel imaging assemblies is configured for a side view of the sample stage;
illuminating a biological sample on the sample stage with a white light source;
irradiating the biological sample, together with the illuminating, with a fluorescence excitation light source at an excitation wavelength in order to stimulate fluorescence of a biocompatible dye within the biological sample at a predetermined emission wavelength, wherein the illuminating from the white light source is through a bandpass, notch, or shortpass optical filter that blocks the emission wavelength from the white light source, thereby inhibiting preventing specular or diffuse reflections caused by the white light source at the emission wavelength:
taking a color picture with the color camera together with capturing a fluorescence image at the emission wavelength with the fluorescence camera in at least one of the dual-channel imaging assemblies; and
rendering the color picture and the fluorescence image for output to a display.

22. (canceled)

23. The method of claim 21 wherein the sample stage is a rotatable sample stage having an axis of rotation.

24. The method of claim 23 wherein the color picture and the fluorescence image are part of real-time video streams being rendered to the display, the method further comprising:
monitoring a rate of movement of the biological sample on the rotatable sample stage;
determining that the rate of movement has descending below a threshold rate;
sending, based on the determining, a trigger to the fluorescence cameras; and
lengthening an integration time of the fluorescence camera pixel sensors based on the trigger.

25. The method of claim 23 wherein the color picture and the fluorescence image are part of real-time video streams being rendered to the display, the method further comprising:
monitoring a rate of movement of the biological sample on the rotatable sample stage;
determining that the rate of movement has descending below a threshold rate; and
alternating, based on the determining, between taking color pictures while the white light source is illuminating and capturing fluorescence images while the fluorescence excitation light source is irradiating.
